(19) United States
(12) Patent Application Publication
(10) Pub. No.: US 2026/0206122 A1
(43) Pub. Date: Jul. 16, 2026

(54) VACUUM DUCT AND ACCELERATOR

(71) Applicants: KABUSHIKI KAISHA TOSHIBA, Kawasaki-shi (JP); TOSHIBA ENERGY SYSTEMS & SOLUTIONS CORPORATION, Kawasaki-shi (JP)

(72) Inventors: Hiroto YAMADA, Yokohama Kanagawa (JP); Koichi ESAKI, Yokohama Kanagawa (JP)

(73) Assignees: KABUSHIKI KAISHA TOSHIBA, Kawasaki-shi (JP); TOSHIBA ENERGY SYSTEMS & SOLUTIONS CORPORATION, Kawasaki-shi (JP)

(21) Appl. No.: 19/562,460

(22) Filed: Mar. 10, 2026

Related U.S. Application Data
(63) Continuation of application No. PCT/JP2024/043406, filed on Dec. 9, 2024.

(30) Foreign Application Priority Data
Apr. 1, 2024 (JP) 2024-059201

(51) Int. Cl. H05H 7/14

(52) U.S. Cl. CPC H05H 7/14

(57) ABSTRACT

Provided are a vacuum duct and an accelerator that allow charged particles to pass in intersecting directions, without having to have a plurality of ducts with different degrees of vacuum three-dimensionally intersect with each other. According to one embodiment, a vacuum duct includes: a first duct configured to form a first beam trajectory of charged particles; a vacuum chamber provided in a straight part of the first duct; and a second duct configured to form a second beam trajectory that intersects with the first beam trajectory inside the vacuum chamber.

### CROSS-REFERENCE TO RELATED APPLICATIONS

This application is a Continuation Application of No. PCT/JP2024/043406, filed on December 9, 2024, and the PCT application is based upon and claims the benefit of priority from Japanese Patent Applications No. 2024-059201, filed on April 1, 2024, the entire contents of which are incorporated herein by reference.

### TECHNICAL FIELD

Embodiments of the present invention relate to a vacuum duct and an accelerator that allow charged particles to pass through.

### BACKGROUND

Studies are being conducted to apply charged particle beams in a high-energy state, obtained by supplying charged particles (ions) to an accelerator and accelerating the same, to a wide range of fields including engineering and medicine. An accelerator system that is currently widely used is mainly formed from an ion source, a linear accelerator, and a circular accelerator, and charged particles are accelerated in a stepwise manner in such an order. When the charged particles orbiting in the circular accelerator reach a predetermined energy, an emission control device is operated, and the charged particle beam whose traveling direction is changed from the orbit is extracted into a beam transport system.

When gas molecules are present in a passage region for charged particles in the circular accelerator, accelerated charged particles may disappear due to charge change or scattering due to interaction. Accordingly, the passage region for charged particles in the circular accelerator is formed inside a vacuum duct that is set to an ultra high degree of vacuum.

Compared with the circular accelerator, a high degree of vacuum is not demanded in relation to the beam transport system connecting the ion source and the circular accelerator. This is because in contrast to the circular accelerator where the charged particles pass repeatedly, the charged particles pass only once through the beam transport system, and also, the passing speed thereof is low.

### PRIOR ART DOCUMENT

### PATENT DOCUMENT

[Patent Document 1] JP 2021-012776 A

### SUMMARY

### PROBLEM TO BE SOLVED BY INVENTION

Recent years have seen a reduction in the size of circular accelerators, and the ion source and the linear accelerator, which were conventionally arranged inside the circular accelerator, have to be arranged outside the circular accelerator. Accordingly, for the sake of arrangement of devices, the circular accelerator and the beam transport system may have to three-dimensionally intersect with each other. It then becomes necessary to provide an additional deflection electromagnet at the vacuum duct to bend a beam trajectory of the charged particles passing through the beam transport system.

Embodiments of the present invention have been made in view of the circumstances described above, and are aimed at providing a vacuum duct and an accelerator that allow charged particles to pass in intersecting directions, without having to have a plurality of ducts with different degrees of vacuum three-dimensionally intersect with each other.

### BRIEF DESCRIPTION OF DRAWINGS

FIG. 1 is a system top view of an accelerator equipped with a vacuum duct according to an embodiment of the present invention.

FIG. 2(A) is a horizontal cross-sectional view of a vacuum duct according to a first embodiment, and FIG. 2(B) is a vertical cross-sectional view thereof.

FIG. 3 is a horizontal cross-sectional view of a vacuum duct, according to each embodiment, provided with focus lens elements for a charged particle beam.

FIG. 4 is a horizontal cross-sectional view of the vacuum duct, according to each embodiment, provided with on-off valves for a charged particle beam.

FIG. 5 is a horizontal cross-sectional view of a vacuum duct according to a second embodiment.

FIG. 6 is a horizontal cross-sectional view of a vacuum duct according to a third embodiment.

### DETAILED DESCRIPTION

### First Embodiment

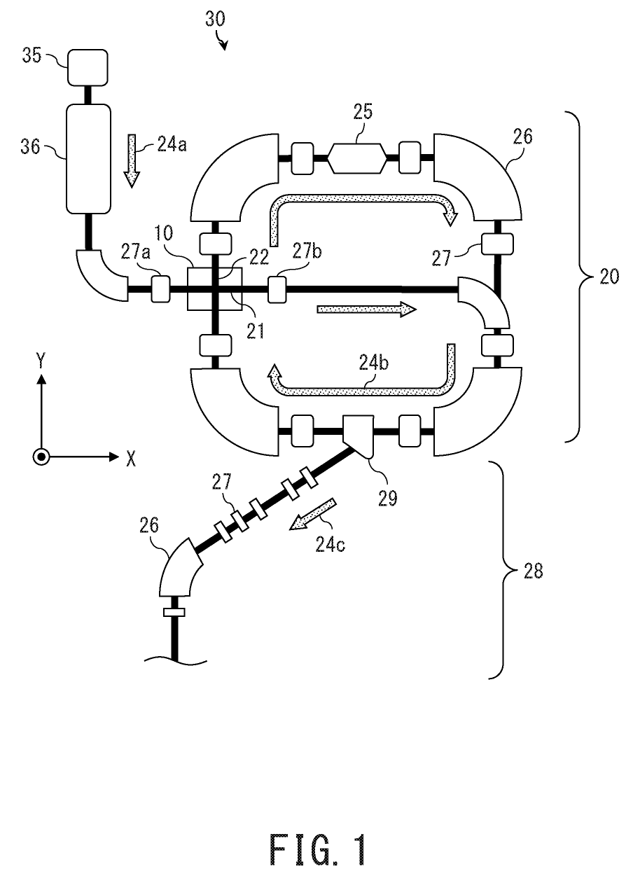

In the following, embodiments of the present invention will be described with reference to the drawings. FIG. 1 is a system top view of an accelerator 30 equipped with a vacuum duct 10 according to an embodiment of the present invention. The accelerator 30 includes an ion source 35, a linac 36 that is a linear accelerator, and a synchrotron 20 that is a circular accelerator, and a charged particle beam 24 (24a, 24b) is accelerated in a stepwise manner in such an order. When charged particles orbiting the synchrotron 20 reach a predetermined energy, an emission device 29 is operated in a state where the energy is maintained, and a charged particle beam 24c whose traveling direction is changed from the orbit is extracted into a beam transport system 28.

Aspects of the ion source 35 include a laser-irradiation ion source in addition to high-frequency (including microwave) irradiation ion sources such as an ECR (Electron Cyclotron Resonance) ion source and a PIG (Penning Ionization Gauge) ion source, but are not limited thereto.

The linac 36 arranges, in a straight line, a plurality of accelerating electric fields, where adjacent accelerating electric fields have opposite electric field components, repeatedly inverts an electric field direction at a high frequency, and always accelerates the charged particle beam 24a passing through the accelerating electric field in only one direction. Furthermore, the linac 36 accelerates ions entering from the ion source 35 to a predetermined energy and then emits the ions to the synchrotron 20.

The synchrotron 20 includes: a radio-frequency acceleration cavity 25 configured to accelerate the charged particles entering from the linac 36 by high-frequency power; a plurality of deflection electromagnets 26 configured to generate a magnetic field that applies a centripetal force to orbiting charged particles; a plurality of quadrupole electromagnets 27 configured to generate a magnetic field that diverges and converges the orbiting charged particles and holds the charged particles in the orbit; and the emission device 29 configured to emit the charged particle beam 24b orbiting in the synchrotron 20 to the beam transport system 28.

The synchrotron 20 configured in the above manner accelerates the charged particles entering from the linac 36 at a low energy to finally an upper limit energy that is 70% to 80% of a speed of light while causing the charged particles to keep orbiting, and causes the charged particle beam 24c to pass through the beam transport system 28.

Additionally, the beam transport system 28 is also provided with the quadrupole electromagnets 27 configured to keep, in the trajectory, the charged particle beam 24c that is traveling straight, and the deflection electromagnet 26 configured to apply the centripetal force to the charged particle beam 24c and bend the trajectory. Equipment (not shown) configured to radiate the charged particle beam 24c is connected at a tip of the beam transport system 28.

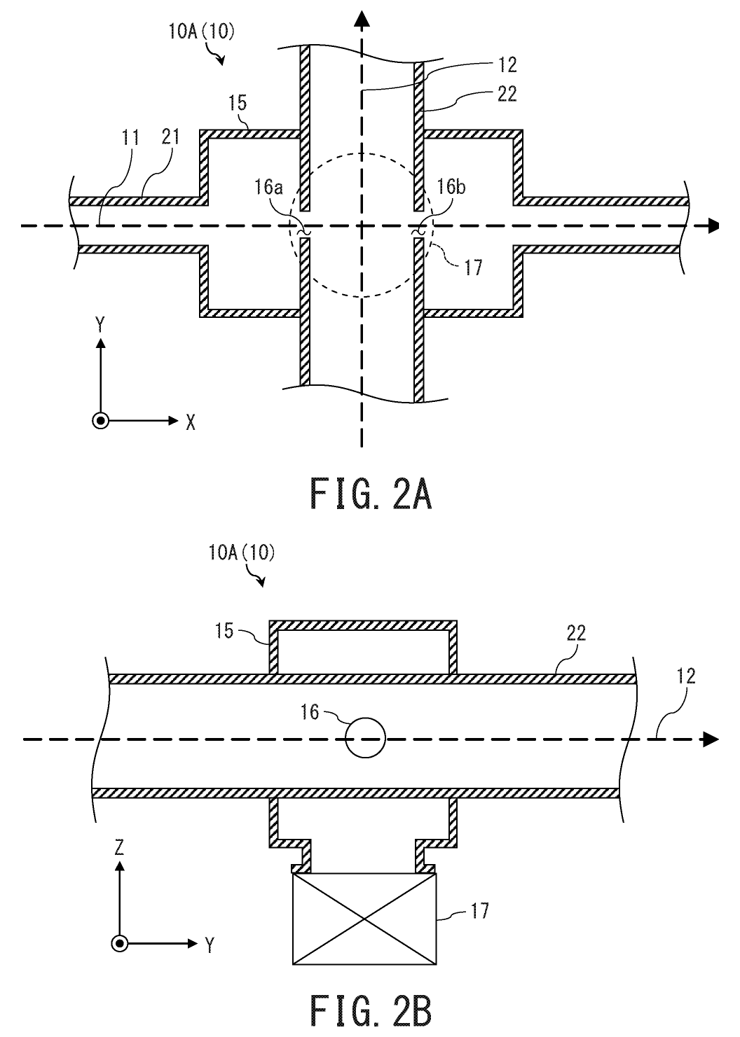

FIG. 2(A) is a horizontal cross-sectional view of a vacuum duct 10A (10) according to a first embodiment. FIG. 2(B) is a vertical cross-sectional view of the vacuum duct 10A (10). As illustrated, the vacuum duct 10A includes: a first duct 21 configured to form a first beam trajectory 11 of charged particles; a vacuum chamber 15 provided in the first duct 21 at an intermediate position of a straight part of the first duct 21, the straight part being divided by the vacuum chamber 15; and a second duct 22 configured to form a second beam trajectory 12 that intersects with the first beam trajectory 11 inside the vacuum chamber 15.

The first duct 21 forms a part of the beam transport system extending from the linear accelerator side (the ion source 35 and the linac 36). The second duct 22 forms a part of the circular accelerator (the synchrotron 20).

With the vacuum duct 10A, the second duct 22 penetrates the vacuum chamber 15, and is provided with openings 16 (16a, 16b) configured to allow the first beam trajectory 11 to pass. A vertical cross-section of the vacuum chamber 15 is sufficiently larger than those of the first duct 21 and the second duct 22. The openings 16 (16a, 16b) are formed to be sufficiently smaller than a vertical cross-section of the second duct 22. Accordingly, an effect of differential pumping is obtained, and inflow of gas molecules from the vacuum chamber 15 connected to the first duct 21 to the second duct 22 can be suppressed.

The differential pumping refers to the following. When connecting the first duct 21 with a relatively low degree of vacuum and the second duct 22 with a higher degree of vacuum, the vacuum chamber 15 with a sufficiently larger volume than the ducts is provided, and a vacuum pump 17 with a large diameter is connected to the vacuum chamber 15 via a short distance. Accordingly, conductance of the first duct 21 and the second duct 22 can be made smaller than conductance of the vacuum pump 17, and an amount of inflow of gas molecules to the second duct 22 with a high degree of vacuum can be suppressed, and a difference in the degree of vacuum between the second duct 22 with a high degree of vacuum and the first duct 21 with a low degree of vacuum can be stably maintained. Furthermore, a three-dimensional structure using an electromagnet or the like is not necessary at the time of causing the first duct 21 and the second duct 22 to intersect with each other.

Furthermore, in FIG. 2(B), the vacuum pump 17 is provided on a bottom surface of the vacuum chamber 15 of the vacuum duct 10A. However, such a configuration is not restrictive, and the vacuum pump 17 may be provided on an upper surface or a side surface of the vacuum chamber 15, or a plurality of vacuum pumps 17 may be installed in the upper surface and the side surface of the vacuum chamber 15. When viewed from outside, the first duct 21 and the second duct 22 are connected to side surfaces of the vacuum chamber 15, and thus, a degree of freedom is high in relation to positions and number of vacuum pumps 17 to be installed. Accordingly, the degree of vacuum can be enhanced while avoiding interference with peripheral devices.

Additionally, the vacuum pump 17 does not have to be installed on the vacuum chamber 15. Alternatively, an inner surface of the vacuum chamber 15 may be coated with or provided with a substance (getter pump) that achieves a gettering effect of absorbing gas molecules. With such a getter pump, gas molecules can be absorbed without affecting the charged particle beam 24, high-conductance evacuation can be achieved, and a high degree of vacuum can be maintained inside the vacuum chamber 15.

Additionally, with the vacuum duct 10 incorporated in the accelerator 30 (FIG. 1) of the embodiment, the vacuum chamber 15 is provided on the first duct 21 with a lower vacuum than the second duct 22. Accordingly, reduction in the degree of vacuum caused by gas leaked from the vacuum chamber 15 or released from an inner surface thereof entering the duct on a higher vacuum side (the second duct 22) can be suppressed, and loss of a beam that passes through the duct and that is accelerated can be reduced.

However, such a configuration is not restrictive, and the first duct 21 where the vacuum chamber 15 is provided may be set to a higher vacuum than the second duct 22. Furthermore, the first duct 21 and the second duct 22 are described to have different degrees of vacuum, but the degree of vacuum may be the same.

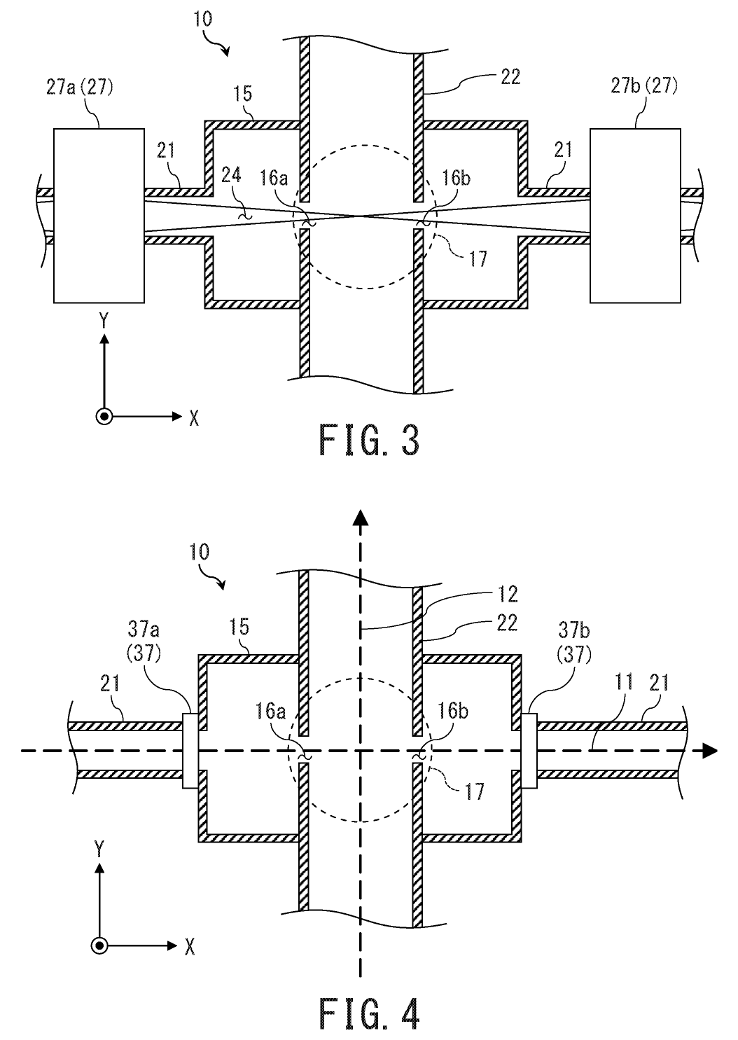

FIG. 3 is a horizontal cross-sectional view of the vacuum duct 10 provided with focus lens elements for the charged particle beam 24. As illustrated, the first duct 21 is provided with a pair of quadrupole electromagnets 27 (27a, 27b) as lens elements configured to focus the charged particle beam 24, one on each side of the vacuum chamber 15.

By providing the quadrupole electromagnets 27 (27a, 27b) and focusing the charged particle beam 24, a diameter size of the openings 16 (16a, 16b) formed in the second duct 22 can be reduced. Accordingly, reduction in the degree of vacuum of the duct on the higher vacuum side (the second duct 22) can be suppressed, and loss of a beam that passes through the duct and that is accelerated can be further reduced.

FIG. 4 is a horizontal cross-sectional view of the vacuum duct 10 provided with on-off valves 37 for the charged particle beam. As illustrated, the first duct 21 is provided with the on-off valves 37 (37a, 37b) that are disposed at positions on opposite sides of the vacuum chamber 15. Since the first duct 21 with a relatively low degree of vacuum is provided with the on-off valves 37 (37a, 37b), the on-off valves 37 can be set to open only when the beam passes and can be closed at other times. Accordingly, reduction in the degree of vacuum of the duct on the higher vacuum side (the second duct 22) can be suppressed, and loss of a beam that passes through the duct and that is accelerated can be further reduced.

### Second Embodiment

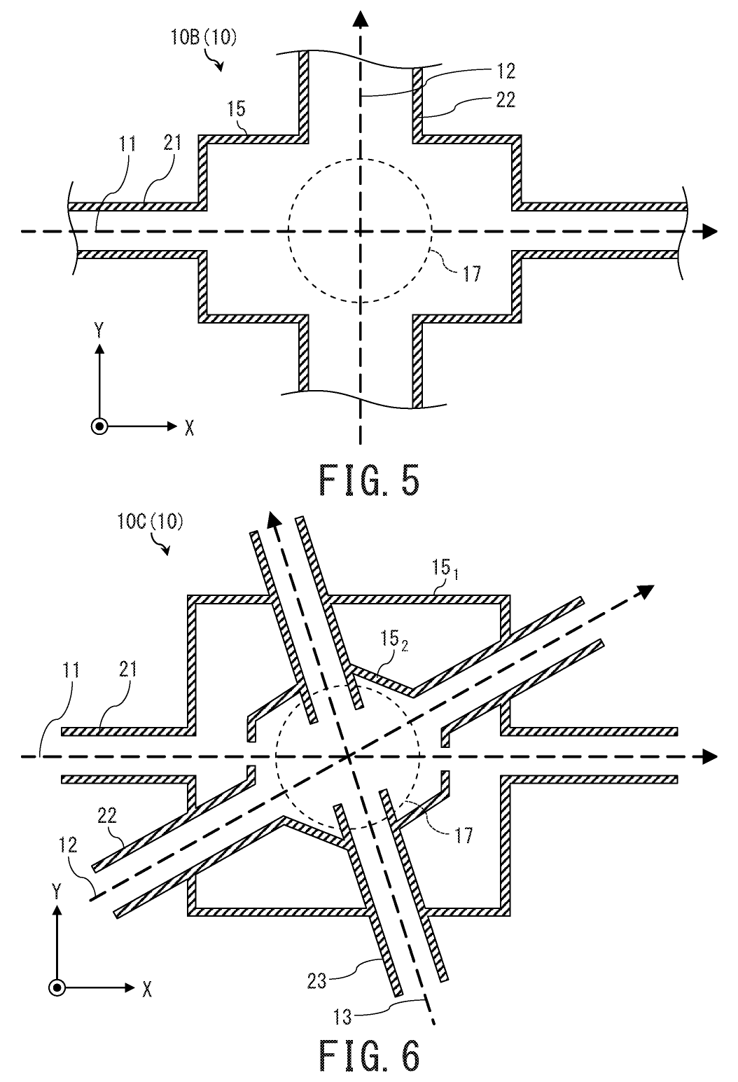

Next, a second embodiment of the present invention will be described with reference to FIG. 5. FIG. 5 is a horizontal cross-sectional view of a vacuum duct 10B (10) according to the second embodiment. Compared with the configuration of the first embodiment described above, the vacuum duct 10B of the second embodiment is configured such that a straight part of the second duct 22 is divided at an intermediate position and is joined to an outer peripheral surface of the vacuum chamber 15. In other words, the vacuum duct 10B is configured such that the straight part of the second duct 22 is divided at an intermediate position to define two end portions and the two end portions are joined to the outer peripheral surface of the vacuum chamber 15. Additionally, in FIG. 5, parts having same configuration or function as those in FIG. 1 are denoted by same reference numerals, and redundant description will be omitted.

The second embodiment is desirable when there is no significant difference in the degree of vacuum between the first duct 21 and the second duct 22, or when inflow of gas molecules from one duct to the other does not cause a problem, for example. Furthermore, by adopting the on-off valves 37 for the charged particle beam shown in FIG. 4, reduction in the degree of vacuum of the duct on the higher vacuum side (the second duct 22) can be suppressed, and loss of a beam that passes through the duct and that is accelerated can be reduced.

### Third Embodiment

Next, a third embodiment of the present invention will be described with reference to FIG. 6. FIG. 6 is a horizontal cross-sectional view of a vacuum duct 10C (10) according to the third embodiment. The vacuum duct 10C of the third embodiment is configured such that the number N of ducts that are provided is three or more (N = 3 in the drawing). Additionally, in FIG. 6, parts having same configuration or function as those in FIG. 1 are denoted by same reference numerals, and redundant description will be omitted.

The vacuum duct 10C includes: the first duct 21 configured to form the first beam trajectory 11 of charged particles; a first vacuum chamber 15₁ provided in the first duct 21 at an intermediate position of a straight part of the first duct 21, the straight part of the first duct 21 being divided by the vacuum chamber 15₁; and the second duct 22 configured to form the second beam trajectory 12 that intersects with the first beam trajectory 11 inside the first vacuum chamber 15₁. The vacuum duct 10C further includes: a second vacuum chamber 15₂ provided in the second duct 22 at an intermediate position of a straight part of the second duct 22, the straight part of the second duct 22 being divided by the second vacuum chamber 15₂; and a third duct 23 configured to form a third beam trajectory 13 that intersects with the second beam trajectory 12 inside the second vacuum chamber 15₂.

Moreover, the vacuum duct 10C of the third embodiment can be expanded in such a manner that the number N of ducts is equal to or greater than three. In this case, for every natural number n in a range of three to N, the vacuum duct 10C includes: an n-1th vacuum chamber that is provided in an n-1th duct at an intermediate position of a straight part of the n-1th duct, the straight part of the n-1th duct being divided by the n-1th vacuum chamber; and an n-th duct configured to form an n-th beam trajectory that intersects with an n-1th beam trajectory inside the n-1th vacuum chamber.

A number N of ducts (where N is three or more) with different degrees of vacuum can thus be caused to intersect with one another while suppressing changes in the degrees of vacuum. In this case, the vacuum duct 10C can be configured by including the first duct 21 with a lowest degree of vacuum, the second duct 22 with a second lowest degree of vacuum, and the n-th duct with a highest degree of vacuum.

With the vacuum duct of at least one embodiment described above, the first duct and the second duct are connected to the vacuum chamber in such a way that the first beam trajectory of the first duct and the second beam trajectory of the second duct intersect with each other inside the vacuum chamber, and thus, it is possible to provide a vacuum duct and an accelerator that allow charged particles to pass in intersecting directions, without having to have a plurality of ducts with different degrees of vacuum three-dimensionally intersect with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions, changes, and combinations in the form of the embodiments described herein may be made without departing from the spirit of the inventions. The accompanying claims and their equivalents are intended to cover such forms or modifications as would fall within the scope and spirit of the inventions.

1. A vacuum duct comprising:
a first duct configured to form a first beam trajectory of charged particles;
a vacuum chamber provided in a straight part of the first duct; and
a second duct configured to form a second beam trajectory that intersects with the first beam trajectory inside the vacuum chamber.

2. The vacuum duct according to claim 1, wherein the second duct penetrates the vacuum chamber, and is provided with openings configured to allow the first beam trajectory to pass.

3. The vacuum duct according to claim 2, wherein the first duct is provided with lens elements that are disposed at positions on opposite sides of the vacuum chamber and are configured to focus a beam of the charged particles.

4. The vacuum duct according to claim 1, wherein a straight part of the second duct is divided at an intermediate position and is joined to an outer peripheral surface of the vacuum chamber.

5. The vacuum duct according to claim 1, wherein the vacuum chamber is provided with a vacuum pump.

6. The vacuum duct according to claim 1, wherein a degree of vacuum is different between the first duct and the second duct.

7. The vacuum duct according to claim 1, wherein the first duct is provided with on-off valves that are disposed at positions on opposite sides of the vacuum chamber.

8. The vacuum duct according to claim 1, wherein
a number N (N ≥ 3) of ducts is set, and
the vacuum duct includes, for every natural number n in a range of three to N,
an n-1th vacuum chamber that is provided in an n-1th duct at an intermediate position of a straight part of the n-1th duct, the straight part of the n-1th duct being divided by the n-1th vacuum chamber, and
an n-th duct configured to form an n-th beam trajectory that intersects with an n-1th beam trajectory inside the n-1th vacuum chamber.

9. An accelerator comprising the vacuum duct according to claim 1.

10. The vacuum duct according to claim 2, wherein the vacuum chamber is provided with a vacuum pump.

11. The vacuum duct according to claim 3, wherein the vacuum chamber is provided with a vacuum pump.

12. The vacuum duct according to claim 4, wherein the vacuum chamber is provided with a vacuum pump.

13. The vacuum duct according to claim 2, wherein a degree of vacuum is different between the first duct and the second duct.

14. The vacuum duct according to claim 3, wherein a degree of vacuum is different between the first duct and the second duct.

15. The vacuum duct according to claim 4, wherein a degree of vacuum is different between the first duct and the second duct.

16. The vacuum duct according to claim 2, wherein the first duct is provided with on-off valves that are disposed at positions on opposite sides of the vacuum chamber.

17. The vacuum duct according to claim 3, wherein the first duct is provided with on-off valves that are disposed at positions on opposite sides of the vacuum chamber.

18. The vacuum duct according to claim 4, wherein the first duct is provided with on-off valves that are disposed at positions on opposite sides of the vacuum chamber.

19. The vacuum duct according to claim 2, wherein
a number N (N ≥ 3) of ducts is set, and
the vacuum duct includes, for every natural number n in a range of three to N,
an n-1th vacuum chamber that is provided in an n-1th duct at an intermediate position of a straight part of the n-1th duct, the straight part of the n-1th duct being divided by the n-1th vacuum chamber, and
an n-th duct configured to form an n-th beam trajectory that intersects with an n-1th beam trajectory inside the n-1th vacuum chamber.

20. The vacuum duct according to claim 3, wherein
a number N (N ≥ 3) of ducts is set, and
the vacuum duct includes, for every natural number n in a range of three to N,
an n-1th vacuum chamber that is provided in an n-1th duct at an intermediate position of a straight part of the n-1th duct, the straight part of the n-1th duct being divided by the n-1th vacuum chamber, and
an n-th duct configured to form an n-th beam trajectory that intersects with an n-1th beam trajectory inside the n-1th vacuum chamber.
